(19) United States
(12) Patent Application Publication
(10) Pub. No.: US 2003/0078973 A1
(43) Pub. Date: Apr. 24, 2003

(54) Web-enabled system and method for on-demand distribution of transcript-synchronized video/audio records of legal proceedings to collaborative workgroups

(76) Inventors: Michael V. Przekop, San Ramon, CA (US); Kirk H. Knight, Alameda, CA (US); Michael J. Donovan, San Francisco, CA (US)

Correspondence Address: GLENN PATENT GROUP, 3475 EDISON WAY, SUITE L, MENLO PARK, CA, 94025, US

(21) Appl. No.: 10/255,807

(22) Filed: Sep. 25, 2002

Related U.S. Application Data
(60) Provisional application No. 60/325,155, filed on Sep. 25, 2001.

(51) Int. Cl. G06F 15/16; H04L 12/16; H04Q 11/00

(52) U.S. Cl. 709/204; 709/231; 370/260

(57) ABSTRACT

In a system and method for distributing transcript-synchronized video/audio records of legal proceedings, a server provides storage for video/audio records and corresponding transcripts. Server-side software synchronizes transcript and video/audio record so that each transcript line is synchronized to corresponding portion of the video/audio record, each transcript line containing a selectable link to the corresponding portion of the video/audio record. Members download record and transcript for review, selecting links to view desired portions of the record, adding page and line designations and annotations to the transcript, as desired. The annotated transcript is uploaded to the server, where separate iterations are tracked. Changes are distributed in real time, or merged and distributed at predetermined intervals. The server edits the video/audio record based on page and line designations, creating a corresponding sequence of video clips. The sequence is viewed in real time, or distributed, at predetermined intervals, to group members.

### CROSS REFERENCE TO RELATED APPLICATION

This application claims benefit of U.S. Provisional Patent Application Serial No. 60/325,155, filed on Sep. 25, 2001.

### BACKGROUND OF THE INVENTION

1. Field of the Invention

The invention pertains to networked systems and methods for collaboration among geographically dispersed workgroups. More particularly, the invention relates to web-enabled systems and methods for distributing transcript-synchronized video/audio records of legal proceedings to members of a collaborative workgroup.

2. Description of Related Technology

It is becoming more and more common in legal proceedings such as litigation to make video/audio recordings of depositions. The use of the video/audio record at trial has proven extremely useful by allowing jurors to observe a deponent's demeanor first hand. Formerly, when jurors only had access to the deponent's testimony through reference to a textual transcript of the deposition, the information provided by the deponent's visual appearance, and voice timbre and tone was lost. By providing a video/audio record of the deposition, such information becomes available, and may have a significant influence on a juror's opinion regarding the deponent's credibility. On the one hand, if the deponent appears sincere and sympathetic, the juror may give more credence to the deponent's statements. On the other hand, if the deponent's demeanor is incongruent with his or her testimony, it may undermine his or her credibility. Thus, legal teams have found video recorded depositions to be a powerful tool.

There are also many situations where the deponent may be deceased by the time the case reaches trial. This is frequent in cases concerning injury, medical practices, or class actions arising from product liability. In such situations the video/audio record is the only way a jury can experience testimony of the witness and render a just verdict.

Whatever advantages video contributes to a deposition, the tradition of the law is text. The administrative overhead imposed by dealing with video and paper separately is formidable. In large cases involving large numbers of depositions, each with an associated video/audio record, it may be necessary to make tens or hundreds of copies of the video and the transcript and express ship them to different cities, states or foreign countries. Often page and line designations, that is, selected witness statements, need to be faxed among attorneys, or they need to be faxed to video editors. There may be long delays waiting for video editing, duplication and shipping. Inevitably, small errors result from such things as handwritten notes and unreadable photocopies. Separation of paper and video makes access to the materials clumsy, and may result in lost opportunities when trying to quickly compare a deponent's demeanor with the transcript. Accordingly, it would be a great advantage to provide a way of synchronizing the deposition transcript to the video/audio record, so that any portion of the video may be quickly and easily accessed by referring to the transcript.

R. Miller, et al., Automatic editing of recorded video elements synchronized with a script text read or displayed, U.S. Pat. No. 5,801,685 (Sep. 1, 1998) provides a video editing system that allows dynamic synchronization of a script text to be read or displayed with the video element is played. Miller, et al. doesn't contemplate synchronizing video deposition with transcripts. Furthermore, the script is to be read or displayed as the video element is played; there is no indication that the transcript can be used to achieve random access to the video record.

Synchronized deposition tools that provide single user desktop access are known. These technologies use text to drive the video, but only work on a user machine. They also typically use proprietary file formats for the video/audio/text that create problems with compatibility and portability, a significant issue when a number of geographically dispersed collaborators are involved on a project. Additionally, a user, such as an attorney, will have a pressing need to access the material without having access to a system containing the required software, leading to significant delays. Furthermore, implementation of these technologies is expensive, sometimes requiring purchases amounting to several hundred dollars per seat.

Technologies are known that enable streaming video to be synchronized with text. Such technologies have not contemplated application to video recording of depositions. Furthermore, they do not contemplate distribution of video/audio records to members of a collaborative workgroup in which members may add annotations and page and line designations to transcripts and share their changes in real time with the rest of the workgroup. Furthermore, they do not contemplate editing of a video record based on designations and annotations made by group members. Furthermore, they do not contemplate methods of highly restricting the ability of unauthorized users to access the video/audio records over a public network such as the Internet.

There exists therefore a need in the art for a system that allows secure distribution of video/audio records to members of a collaborative workgroup, in particular records of legal proceedings, such as depositions, in which each line of the transcript is synchronized to the corresponding portion of the video record. It would be desirable to embed selectable links in the transcript so that group members could access a desired portion of the video record by selecting the link embedded in the corresponding line of the transcript. It would desirable to provide the capability of adding page and line designations and annotations to the transcript by group members, and virtual editing of the video record based on members' page and line designations. It would be a great advantage to provide group members with the capability of sharing their work with their collaborators easily and quickly. Finally, it would be desirable to implement such a system using open standards as much as possible, thus enabling reduced cost to users, ease of implementation, ease of use, and maximum compatibility and portability.

### SUMMARY OF THE INVENTION

A web-enabled system and method for distributing transcript-synchronized video/audio records of legal proceedings provides a server whereon the video/audio records and corresponding transcripts are stored. Novel software on the server first synchronizes transcript and video/audio record so that a specific moment in the transcript, traditionally the start of each line of the transcript, is synchronized to the corresponding portion of the video/audio record. After synchronization, each line of the transcript contains a selectable link to the video/audio record so that a permitted viewer, by simply selecting a link, is securely navigated to the corresponding portion of the video/audio record over a public network such as the Internet.

Using open-standard clients such as web browsers, individual members of a collaborative workgroup securely download the transcript for review. Group members may view the synchronized video/audio record by selecting a link in the transcript.

Using a variety of open-standard tools, members are allowed to add their own page and line designations and annotations to the downloaded transcript. The annotated version of the transcript is uploaded to the server, where each iteration of the transcript is tracked. Group members have the capability of sharing their annotations and designations with other group members in real time. Alternatively, the server merges all designations and distributes them at predetermined intervals, wherein each change to the transcript is attributed to the member making the change.

The server automatically edits the video/audio record based on the page and line designations, creating a sequence of video/audio clips wherein each clip corresponds to a page and line designation. The sequence can be viewed in real time, or is distributed, with a corresponding textual summary, at predetermined intervals, to members of the group.

Video/audio records and lists of clips are distributed either as open standard video formats such as MPEG-1 files or as video streams. The server scales the video stream according to the type of connection between client and server. The option of saving records and transcripts to a removable storage medium such as a compact disc is also provided.

### BRIEF DESCRIPTION OF THE DRAWINGS

FIG. 1 provides a schematic diagram of a system for distributing transcript-synchronized video/audio records of legal proceedings to members of collaborative workgroups according to the invention;

FIG. 2 provides a block diagram of a method for distributing transcript-synchronized video/audio records of legal proceedings to members of collaborative workgroups according to the invention;

FIG. 3 provides a screen shot of a transcript with page and line designations in a web display, according to the invention; and

FIG. 4 provides a screen shot of a synchronized video/audio record in a streaming video-on-demand web display, according to the invention.

### DETAILED DESCRIPTION

The invention provides a system and method that allows collaborative groups, of attorneys and legal staff, for example, time to explore various scenarios and arguments more thoroughly while dramatically reducing the expense and delays of collaborating on legal proceedings, such as depositions, that have been recorded on video and audio media. The invention makes it practical for geographically dispersed teams to collaborate closely and securely share rapidly changing ideas. Through the use of the Internet and open standard encryption technology, any member of the work group has secure access to his work, anytime, anywhere. Such ease of use coupled with an unprecedented level of security provides a Court the possibility of confidently recommending central repositories for use by all sides in a case, thus expediting the proceeding while greatly reducing cost.

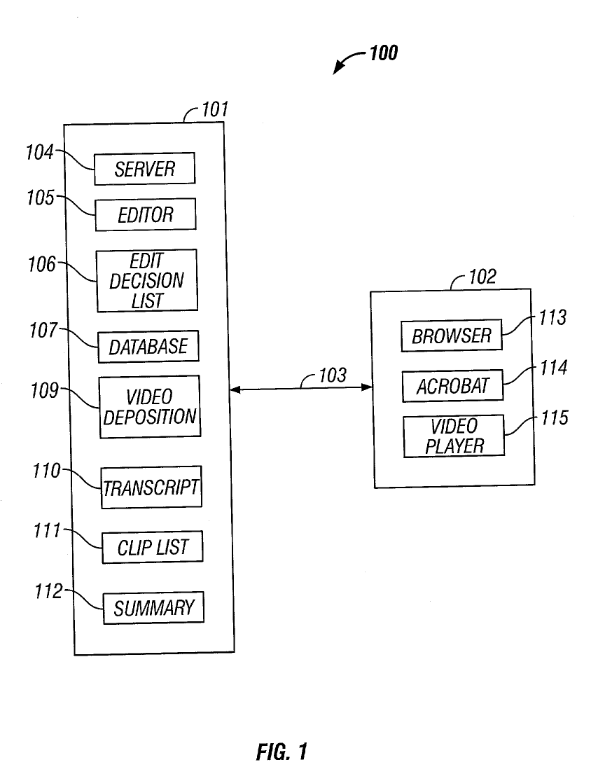

Referring now to FIG. 1, a block diagram of the invented system 100 is shown. While a portion of the server-side software is exclusive to the invention, one skilled in the art will appreciate that the system architecture is based chiefly on conventional, web-enabled open standard technology commonly used for secure financial transactions. On the client side, the invention includes only open standard technology. One skilled in the art will recognize that use of open standard technology provides significant advantages in ease of implementation, reliability, ease of use and reduced cost. Unlike conventional litigation support technologies, the user is not confined to using a proprietary technology that is not portable or convertible.

In the preferred embodiment of the invention a video server 101 and a client 102 are in communication over a network 103, for example a publicly accessible telecommunication network such as the Internet. Video/audio records 109 and accompanying transcripts 110 are stored on the video server 101.

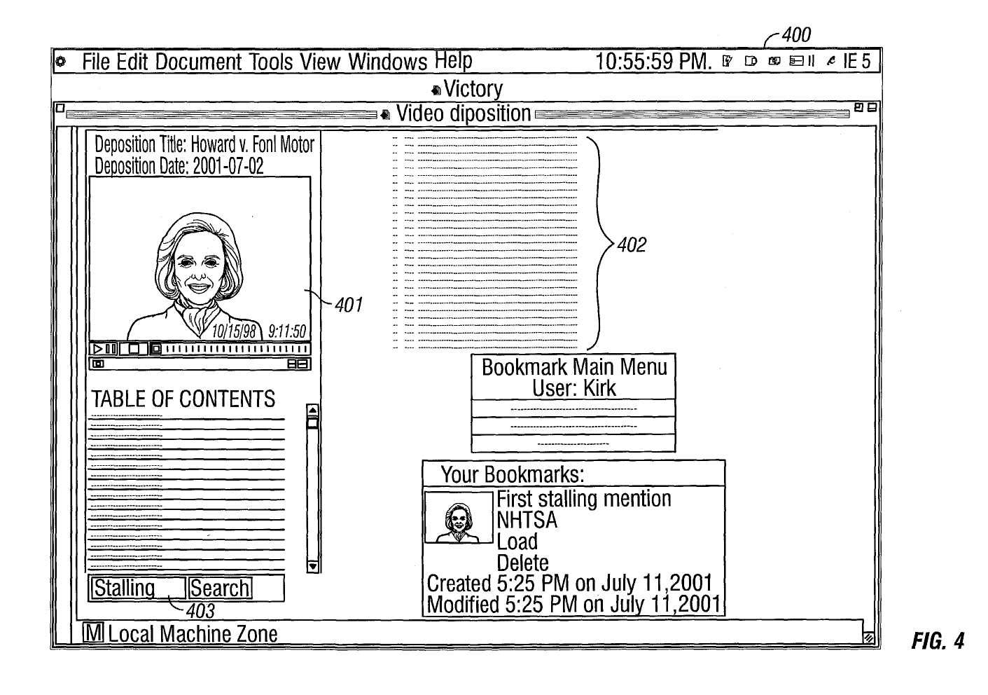

In the preferred embodiment of the invention, the transcripts 109 are converted from text files or word processing files to standard ADOBE ACROBAT .PDF (PORTABLE DOCUMENT FORMAT) files. PDF is a file format, developed by ADOBE SYSTEMS, INC. of San Jose Calif., that captures formatting from most word-processing and desktop publishing applications so that files can be sent, and appear as they were intended when viewed by the recipient using the ACROBAT viewer. As described in greater detail below, the server software 104 embeds information in the transcript file 109 to synchronize the deposition transcript. When a member is connected to the web, clicking on any line of text in the .PDF file displays the portion of the video/audio record synchronized to the specific line, as shown in FIG. 4. As shown in FIG. 1, the client software 102 includes the ACROBAT software 114.

Advantageously, the invention allows a group member, an attorney, for example, to download the transcript for review. Using selection tools provided in the ACROBAT software, the member can select a sentence, the term of art used by attorneys calls this a page and line designation, in the .PDF, save the changed file, and then upload the changed file to the server, ACROBAT also allows the member to make the page and line designations using a tool commonly referred to as a highlighter to select the page and line designations. The server software 104 extracts the new designations and adds them to an historical database 107. Alternately, a web user interface provides a method for a member to enter in the page and line number by typing into a form, which the server software 104 extracts as above.

Subsequently, the member may share his or her page and line designations with other members of the work group, typically a legal team, in real time by instructing the server to distribute the revised file to them; or merge the designations with those of others; or wait until a predetermined time, at the end of a workday period, for example, for the server to automatically merge all designations and distribute them in the form of a new Acrobat .PDF file that reflects the thinking of all group members. The database 107 makes it possible to track iterations and display each designation with attribution to the specific group member, thus freeing the attorney to concentrate on matters of law, rather than devoting precious time to routine administrative tasks.

A further advantage provided by the invention is the capability of editing the video/audio record based on the page and line designations made by group members. Making designations by highlighting or typing-in provides instructions to video editing software 105 to automatically edit the video/audio record into a sequence, or clip list 110 and create an Acrobat PDF summary 112. The resulting video/audio record can be viewed online in real time by all members in the group regardless of their location, or it can be reviewed at the member's leisure.

Furthermore, the edited video can be downloaded at MPEG-1 quality to a desktop or laptop computer and imported to conventional litigation support software for use at trial. Alternatively, a member could instruct the server to automatically write the files to a removable storage medium such as a compact disk and express ship it to a trial location.

The invention employs SSL (SECURE SOCKETS LAYER) encryption for secure session management. Additional security arrangements are possible, ranging from simple password access to highly sophisticated systems requiring physical device encryption at both ends. Due to the sensitive nature of the depositions, access to the video/audio server is conducted over open standard encryption security technologies commonly used for secure online financial transactions. Each group member receives a unique access code. Group member access will require use of a combination of unique user identification and pass phrase to be permitted access to that member's user space. Security methods will also permit the group to restrict access by individual.

As a result of using open standard tools for the transcripts, group members may choose to share the transcript files with third parties beyond the group. Although these third parties will be able to read the transcript, they will be unable to access the video/audio record without an authorized access code due to the security method.

Due to the sensitive nature of the depositions the security method maintains a history of accesses to information on the server. This includes each transcript, the notes as well as the video/audio record. Thus, in the event a group member were to provide an unauthorized third party with an access code resulting in divulging privileged information, an audit could determine each member who accessed the information. This same log system also tracks attempted access by non-members.

The server has the capability of sensing the member's connection speed and scaling the video stream according to the connection type. Thus, for a 56K modem, the video stream is narrower band and of lower quality than on a client having a broadband connection. Additionally, the video stream can be scaled to wireless clients, such as PalmOS or Windows CE devices.

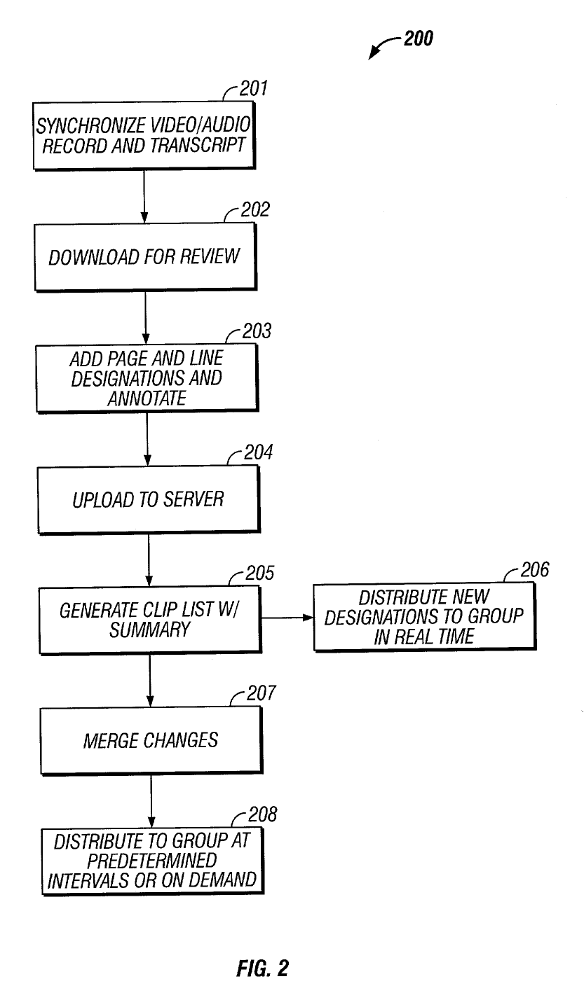

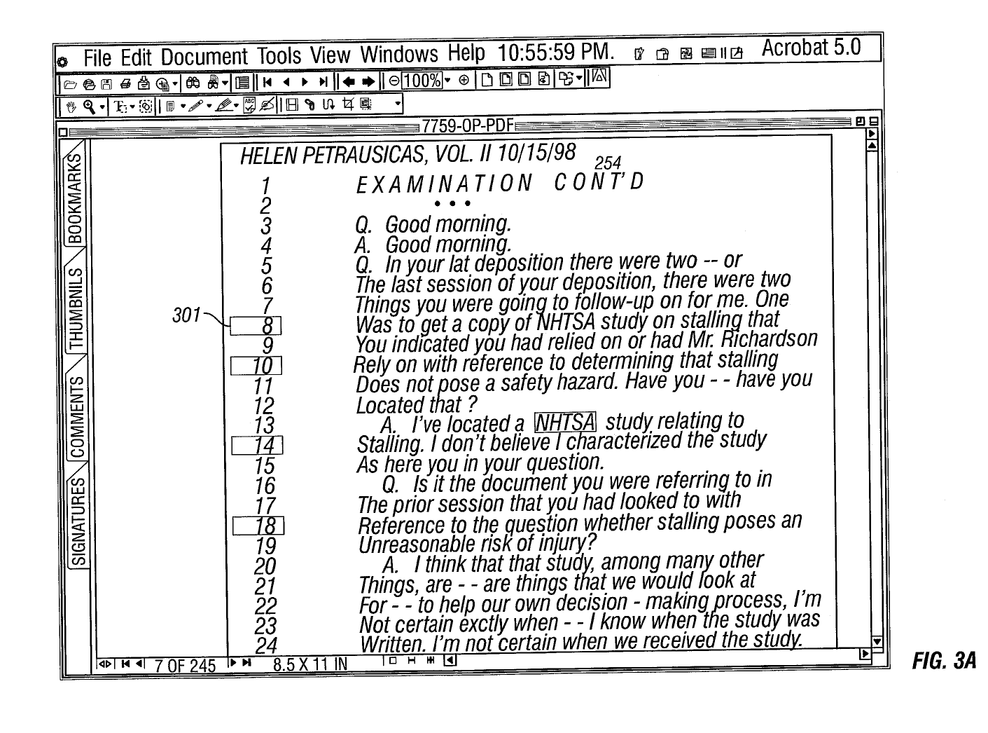

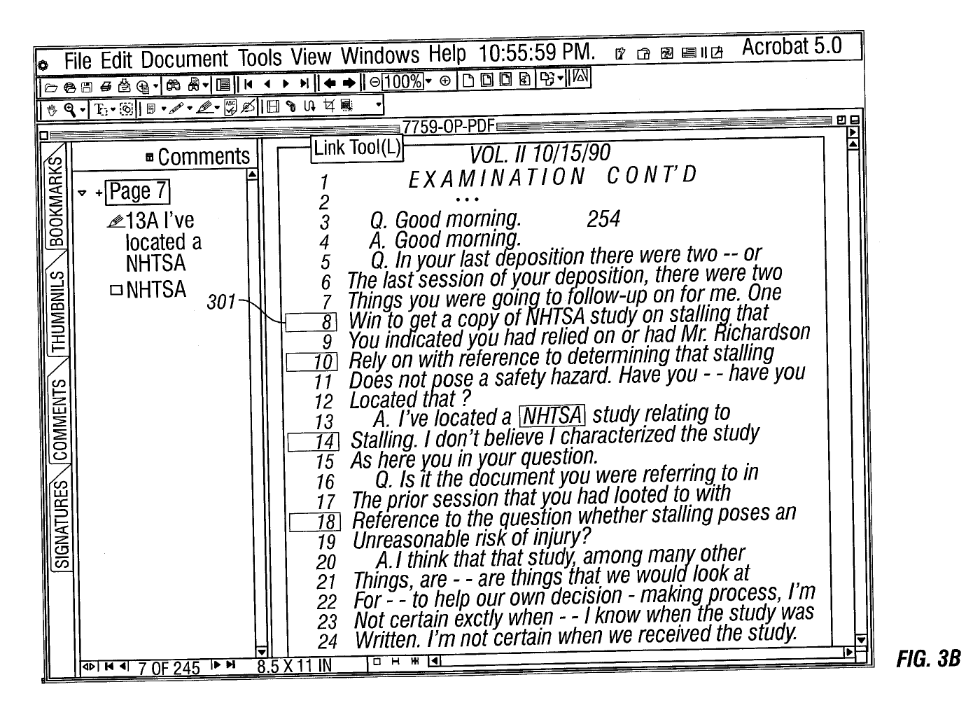

Referring now to FIG. 2, shown is a block diagram of a method 200 according to the invention. As previously described, video/audio records of legal proceedings such as depositions are stored on the server 104 with their accompanying transcripts 109. In the preferred embodiment, the transcript file is first converted to a .PDF. The use of ADOBE ACROBAT and .PDF files provides several important advantages. ACROBAT is accepted by the Federal Judiciary of the United States as a high fidelity digital representation of a legal document. ACROBAT provides an open standard capability of embedding information in the transcript file as selectable links that enable the synchronization 201 of each line of the transcript with the corresponding portion of the video/audio record, such that selecting the link in the transcript navigates the member to the corresponding portion of the video/audio record. The process of synchronization may be performed manually by an operator, wherein the operator examines the transcript and the video/audio record to find a moment when the two media are synchronized. Then, using a software tool, the technician indicates this moment of synchronization. The software captures the SMPTE (SOCIETY OF MOTION PICTURE AND TELEVISION ENGINEERS) time code from the video and audio and inserts this into the .PDF file at the corresponding location in the text. This can be done in a single step, or it may be more convenient to use other software tools that do this in several steps. The synchronization information is inserted in the PDF document in a location that makes it easy for a member to click a link 301 that will synchronize the video and audio. FIG. 3 shows a box 301 around the line number, a term of art also called a page and line number that attorneys use when describing the statements of a deponent. The goal is to synchronize every line of the deposition transcript with the corresponding moment of the video/audio record made at the time of the deposition.

Thus, it becomes possible and simple to synchronize the video server 104 using SMPTE time code information as pointers to specific frames in what could be a very long sequence. Advantageously, the .PDF file includes the SMPTE time code in an indelible synchronized form. Additionally, the .PDF file is easily copied or edited, yet the synchronization information remains fixed. One skilled in the art will also recognize the ease with which it is also possible to synchronize the corresponding lines of text in an ASCII text file with the corresponding portions of the video/audio record by associating them with each other in a database housed on the server.

In a further embodiment of the invention, the process of synchronizing the video/audio record and the transcript is completely automated through the use of a software program executing on the server. The automated system may further include use of fast voice recognition, or sensing changes in the speaker.

As FIG. 2 shows, the member next downloads 202 the transcript and the video/audio record from the server for review. As previously described, the video/audio record may be transmitted as a scalable video stream, or may be downloaded as a MPEG-1 file. Alternatively, the member may access the files from a CD-ROM or comparable removable storage medium. Yet another alternative permits the member to view both transcript and video/audio over the web as shown in FIG. 4. FIG. 4 shows a multi-frame web browser with the video image presented in a first frame 401 and the transcript presented in a second frame 402. The member reviews 203 desired portions of the video/audio record by selecting the corresponding link in the transcript, as shown in FIG. 3. Thus, when the member clicks on the line number, the software opens the browser window and launches the streaming-video-on-demand services, presenting the desired portion of the video/audio record in its own frame. As FIG. 1 shows, the client software includes an open standard video player 115.

During his or her review, the member may add page and line designations, comments and annotations 203 in the text. ACROBAT provides several tools for appending, editing and revising documents. Among these are a highlighter tool for selecting portions of text and another tool for adding annotations to the text. Accordingly, when the member wishes to add a page and line designation to the text, he or she selects the desired text using the highlighter tool. ACROBAT treats this selection as a software object with a set of unique attributes. When the member has finished, changes are saved to a new version of the document that is then uploaded to the server 204.

The server software 104 captures page and line designations made by the member on the .PDF document by comparing the set of software objects in the retrieved .PDF document with a version of the document stored in the database. The preferred embodiment employs XML (EXTENSIBLE MARKUP LANGUAGE) as a convenient translation tool to create a table to associate deponent name, deposition source file, page number, line number, text string and the corresponding SMPTE time code associated with the text of the transcript. One skilled in the art will recognize the ease with which database tools make it practical to use the XML translation table to automatically and rapidly translate from the deposition text string to the SMPTE video time code, or from the video time code to the deposition text string.

The time code sequences, serving as start points and end points for the corresponding video/audio sequences, are then written to an edit decision list 106. The edit decision list may be a tab-delimited text file, a table, or any similar data structure that can be easily read by common streaming video servers or edit software. Subsequently, the edit decision list is passed to a video/audio editing system 105, which automatically generates 205 a list of the desired video clips 111. Additionally, a summary 112 of the clip list is generated in .PDF format for distribution with the clip list 111. Thus, highlighting the .PDF of the deposition automatically results in a new video/audio sequence of selected clips representing the page and line designations.

Making page and line designations in the .PDF is one way to create video clips. Another is to play the video/audio and use a clip tool to designate start and end points. Each user can then save these clips for later recall. The clips can be labeled. Additional fields of information can be added to the clip notes. Since this process relies on a relational database 107 for synchronization, the range of information that can be added and related is extremely large and varied. The clips can then be automatically assembled into an Edit Decision List 106 and a video sequence assembled.

Other embodiments which do not require the use of XML can also be envisioned, largely depending upon the volume, speed, productivity and the preferred toolset.

FIG. 4 shows an example of a synchronized deposition as it may appear in the streaming-video-on-demand web display 400. Since a member will want to see text as well as video, the display includes multiple frames. One part of the display is a frame with streaming video and audio 401. Another frame is a line-by-line text display 402. Clicking on the line of text will cause the video in the display to stop, synchronize to the text, and then start playing. Another frame is a search window 403. As shown, the transcript can be searched for occurrences of the particular term, and the corresponding video/audio portion played.

As previously described, the member may choose to distribute his or her page and line designations 206 to other members of the group immediately. Otherwise, the changes may be merged 207 with those of other members of the group and distributed to the group 208, either on demand or at predetermined intervals.

When a member views the automatically prepared EDL sequence, small edits, commonly called trims, are required to eliminate extra video frames and help the sequence to flow smoother. A human editor may make trim decisions, typically someone who is a skilled video editor or has extensive experience with video editing. Once the human editor makes trim decisions, these choices, represented by a set of SMPTE time code entries, can be appended to the database 107, and the member can resort a sequence, or add or delete clips, while retaining the editor's contributions. The resulting EDL can be output as a new sequence, this time with trims, although in a different sequence. This process is often repeated numerous times before presentation of the final sequence in trial. Presentation at trial can be from a computer as a file stored in memory or on a disk drive, or presentation can be accomplished by exporting the video/audio to a recordable medium such as a CD-ROM or DVD-ROM. These recordable media are then played back on a presentation system in the courtroom.

### EXAMPLE

The advantages of the current invention are better appreciated by reference to a recent example: the depositions in the U.S. v. Microsoft case.

Tens or even hundreds of copies of each transcript and videotape would have been made just to satisfy the needs of the defendant's attorneys, the prosecutors, the various States Attorneys General, Senate and House members and their counsel, the FTC, and other regulatory agencies. The defendant would have incurred the cost of producing the copies and shipping from Seattle to Washington, D.C., New York, or wherever counsel was located.

In spite of the cost and delays, the separation of paper and video made access to the materials clumsy, further delaying the need to get to the heart of the matter. Reading a transcript without the ability to quickly compare the demeanor of a witness can result in either a lost opportunity to impeach the testimony or an unfortunate misunderstanding and waste of time.

Using the current invention, copies could have been placed in separate yet secure locations on the server for use by each and every party. If a judge ruled that a central repository was to be established and used by all, then the same video could have been prepared for use by both sides, yet securely segregated among multiple parties. Attorneys could have had the option of sharing an Acrobat PDF file that had common links and yet was still unique to a specific plaintiff. Having the capability of searching computer text with sophisticated web-enabled inference tools further enhances the value of the video/audio record and the synchronized transcript.

It is likely that attorneys must travel across the country to conduct depositions or investigations. Other members of the team are also in transit. Using a web-enabled system such as the current invention allows team members to stay abreast with current developments. Using the invented system, team members may realize at least the following advantages:

updating their laptops with the latest depositions from all team members;

collaborating with every member of the team regardless of time zone;

reading through depositions at their leisure and highlighting specific lines on specific pages in the depositions and then sharing their designations with the entire team;

building a database of designations with the ease of wielding a simple highlighting tool;

clicking on a highlighted designation and seeing the video of the deposition synchronized to that exact spot within a matter of seconds;

enabling members to see and hear if the demeanor of the witness conflicts with the written word; and

eliminating cumbersome searching through boxes of tapes or CD-ROMs, plus the expense of custom playback software licenses.

As previously described, a portion of the server side software is particular to the invention. Such software is implemented using conventional methods known to those skilled in the art of computer programming. The remainder of the system results from a novel application of readily available open standards technologies. The invented system is implemented using methods known to those in the arts of network engineering and systems integration.

Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below.

1. A system for distributing a transcript-synchronized video/audio record of a legal proceeding to members of a collaborative workgroup on demand, comprising:
a server, wherein said video/audio record and a transcript of said proceeding are stored on said server;
means for synchronizing each line of text in said transcript with a corresponding portion of said video/audio record;
at least one client in communication with said server, wherein said server distributes any of said video/audio record and said transcript to a member using said client on demand;
means for making page and line designations from said transcript by said members; and
means for editing said video/audio record, wherein a list of clips is created and made available on demand to said members;
wherein said system is adapted to a web-based network environment;
wherein said system protects access to privileged video/audio records with secure methods; and
wherein said system is based at least in part on open technology standards.

2. The system of claim 1, wherein said means for synchronizing comprises:
a software program, said program adapted to assign time codes to each frame of said video/audio record.

3. The system of claim 2, wherein said means for synchronizing further comprises:
means for embedding time codes to a corresponding, portion of said video/audio record either at each line of text or a portion thereof in said transcript.

4. The system of claim 3, wherein said embedded time codes comprise selectable links, so that selecting a time code grants a member access to the corresponding portion of said video/audio record.

5. The system of claim 3, wherein said transcript is stored and distributed as a document file having the ability to support embedded links.

6. The system of claim 5, wherein said means for embedding time codes comprises a software program so adapted.

7. The system of claim 5, wherein said means for embedding time codes comprises at least one operator manually inserting time codes.

8. The system of claim 2, wherein said means for synchronizing further comprises:
a database, wherein time codes are captured and related to lines of a text file of said transcript.

9. The system of claim 2, wherein said time codes comprise SMPTE (SOCIETY OF MOTION PICTURE AND ENGINEERS) time codes.

10. The system of claim 1, wherein said video/audio record is stored as a MPEG (MOTION PICTURE EXPERTS GROUP) file.

11. The system of claim 1, wherein said video/audio record is distributed as an MPEG file or in a video stream.

12. The system of claim 11, wherein said video stream is scalable according to type of connection between server and client.

13. The system of claim 1, wherein said transcript, said video/record and said list of clips are distributed on removable storage media.

14. The system of claim 1, wherein said client comprises a web browser.

15. The system of claim 14, wherein said client further comprises a viewer for said video/audio record.

16. The system of claim 14, wherein said client further comprises a software application for viewing and editing said transcript.

17. The system of claim 16, wherein said means for making page and line designations comprises a highlighter tool, wherein a member selects portions of text from said transcript, so that corresponding time codes for said selected portions of text are captured.

18. The system of claim 16, wherein captured time codes for a portion of text designate start and end points of a video/audio sequence corresponding to said portion of text.

19. The system of claim 18, wherein said start and end points are written to an edit decision list.

20. The system of claim 19, said means for editing said video/audio record comprising a video editing system, wherein said edit decision list is passed to said editing system, so that said list of clips is automatically created.

21. The system of claim 16, further comprising tools for any of:
annotating said transcript;
attaching comments to said transcript; and
identifying a member adding a designation, annotation or comment.

22. The system of claim 16, further comprising means for saving member changes to a new version of said transcript and transmitting to said server.

23. The system of claim 22, further comprising a history database at said server wherein said member changes are saved to said history database.

24. The system of claim 16, further comprising means for:
sharing member changes with others in said workgroup;
merging member changes with changes made by other group members;
automatically merging changes made by all members of a workgroup at a predetermined interval and distributing to all group members; and
attributing changes to maker.

25. The system of claim 1, said means for editing said video/audio record comprising:
a clip tool, wherein said user views said video/audio record and designates a start and end point to a clip using said clip tool;
a database, said database providing a plurality of fields for labeling and associating other data with said clip;
an edit decision list, wherein said clip is written to said edit decision list; and
a video editing system, wherein said edit decision list is passed to said editing system, so that said list of clips is automatically created.

26. The system of claim 1, wherein said server comprises a video server.

27. The system of claim 26, wherein said video server comprises a streaming video server.

28. The system of claim 1, wherein said legal proceeding comprises a deposition.

29. The system of claim 1, wherein said client communicates with said server across a publicly accessible telecommunication network.

30. The system of claim 29, wherein said network comprises the Internet.

31. The system of claim 1, further comprising means for providing secure transmission between client and server.

32. The system of claim 31, wherein said means for providing secure transmission comprises means for encrypting transmission between client and server.

33. The system of claim 1, wherein said transcript-synchronized video/audio record is importable to a litigation support software application.

34. A method for distributing a transcript-synchronized video/audio record of a legal proceeding to members of a collaborative workgroup on demand, comprising the steps of:
storing a video/audio record and a transcript of said proceeding on a server;
synchronizing each line of text in said transcript with corresponding frames in said video/audio record;
distributing any of said video/audio record and said transcript from said server to a member using a client in communication with said server on demand;
making page and line designations from said transcript by said members; and
editing said video/audio record, wherein a list of clips is created and made available on demand to said members; and
protecting access to privileged video/audio records with secure methods;
said client and said server communicating in a web-based network environment; and
wherein said method is based at least in part on open technology standards.

35. The method of claim 34, wherein the step of synchronizing comprises:
assigning time codes to each frame of said video/audio record by means of a software program so adapted.

36. The method of claim 35, wherein the step of synchronizing further comprises:
embedding time codes to a corresponding portion of said video/audio record at each line of text in said transcript.

37. The method of claim 36, further comprising the step of:
selecting a time code by a member to access a corresponding portion of said video/audio record, wherein said embedded time codes comprise selectable links.

38. The method of claim 36, wherein said transcript is stored and distributed as a document file having the ability to support embedded links.

39. The method of claim 38, wherein a software program embeds said time codes so adapted.

40. The method of claim 38, wherein said time codes are embedded manually be at least one operator.

41. The method of claim 35, wherein said step of synchronizing further comprises:
capturing and relating time codes to lines of a text file of said transcript in a database.

42. The method of claim 35, wherein said time codes comprise SMPTE time codes.

43. The method of claim 34, wherein said video/audio record is stored as a MPEG (MOTION PICTURE EXPERTS GROUP) file.

44. The method of claim 34, wherein said video/audio record is distributed as an MPEG file or in a video stream.

45. The method of claim 44, wherein said video stream is scalable according to type of connection between server and client.

46. The method of claim 34, wherein said transcript, said video/record and said list of clips are distributed on removable storage media.

47. The method of claim 34, wherein said client comprises a web browser.

48. The method of claim 47, wherein said client further comprises a viewer for said video/audio record.

49. The method of claim 47, wherein said client further comprises a software application for viewing and editing said transcript.

50. The method of claim 49, wherein the step of making page and line designations comprises:
selecting portions of text from said transcript by said member using a highlighter tool, so that corresponding time codes for said selected portions of text are captured.

51. The method of claim 49, wherein captured time codes for a portion of text designate start and end points of a video/audio sequence corresponding to said portion of text.

52. The method of claim 51, further comprising the step of writing said start and end points to an edit decision list.

53. The method of claim 52, said step of editing said video/audio record comprising:
passing said edit decision list to an editing system, so that said list of clips is automatically created.

54. The method of claim 49, further comprising any of the steps of:
annotating said transcript;
attaching comments to said transcript;
identifying a member adding a designation, annotation or comment; and
appending date and/or time of change.

55. The method of claim 49, further comprising the step of:
saving member changes in a new version of said transcript and transmitting to said server.

56. The method of claim 55, wherein said step of saving member changes further comprises:
saving said member changes to a history database at said server.

57. The system of claim 49, further comprising the steps of:
sharing member changes with others in said workgroup;
merging member changes with changes made by other group members;
automatically merging changes made by all members of a workgroup at a predetermined interval and distributing to all group members; and
attributing changes to maker.

58. The method of claim 34, said step of editing said video/audio record comprising the steps of:
viewing said video/audio record by said member and designating a start and end point to a clip using a clip tool;
labeling and associating other data with said clip by means of a database;
writing said clip to an edit decision list; and
passing said edit decision list to a video editing system so that said list of clips is automatically created.

59. The method of claim 34, wherein said server comprises a video server.

60. The method of claim 59, wherein said video server comprises a streaming video server.

61. The method of claim 34, wherein said legal proceeding comprises a deposition.

62. The method of claim 1, wherein said client communicates with said server across a publicly accessible telecommunication network.

63. The system of claim 62, wherein said network comprises the Internet.

64. The method of claim 1, further comprising the step of:
providing secure transmission between client and server.

65. The method of claim 31, wherein said step of providing secure transmission comprises:
encrypting transmission between client and server.

66. The method of claim 1, further comprising the step of:
importing said transcript-synchronized video/audio record to a litigation support software application.
